(19) United States
(12) Patent Application Publication
(10) Pub. No.: US 2025/0224344 A1
(43) Pub. Date: Jul. 10, 2025

(54) Measurements Of Semiconductor Structures Based On Data Collected At Prior Process Steps

(71) Applicant: KLA Corporation, Milpitas, CA (US)

(72) Inventors: Houssam Chouaib, Milpitas, CA (US); Anderson Chou, Hillsboro, OR (US); HaoMiao Chang, Chupei City (TW); Brooks Hsiao, Taoyuan City (TW); Ben Hsieh, New Taipei City (TW); James Chuang, Sunnyvale, CA (US); Zhengquan Tan, Cupertino, CA (US); Derrick Shaughnessy, San Jose, CA (US); Jonathan Iloreta, Menlo Park, CA (US)

(21) Appl. No.: 18/743,048

(22) Filed: Jun. 13, 2024

Related U.S. Application Data
(60) Provisional application No. 63/617,422, filed on Jan. 4, 2024.

(51) Int. Cl. G01N 21/95; G06N 20/00

(52) U.S. Cl. CPC G01N 21/9501; G06N 20/00; G01N 2201/126

(57) ABSTRACT

Methods and systems for using pre-process measurement data to train post-process, machine learning (ML) based measurement models are described herein. In one aspect, a post-process, ML based measurement model is trained using reference data derived from actual reference measurements and estimated reference data generated by a trained mapping model. The trained mapping model maps measured values of parameters of interest at a pre-process state to estimated reference values at the post-process state. In this manner, the reference data employed to train a ML based measurement model is augmented based on pre-process measurement data. In another aspect, measurements of complex semiconductor structures are based on a combined measurement model including trained pre-process and post-process measurement models. Pre-process measurement data is employed directly as part of a combined ML based measurement and indirectly as part of the training data set for the combined ML based measurement model.

### TECHNICAL FIELD

The described embodiments relate to metrology systems and methods, and more particularly to methods and systems for improved measurement accuracy.

### BACKGROUND INFORMATION

Semiconductor devices such as logic and memory devices are typically fabricated by a sequence of processing steps applied to a specimen. The various features and multiple structural levels of the semiconductor devices are formed by these processing steps. For example, lithography among others is one semiconductor fabrication process that involves generating a pattern on a semiconductor wafer. Additional examples of semiconductor fabrication processes include, but are not limited to, chemical-mechanical polishing, etch, deposition, and ion implantation. Multiple semiconductor devices may be fabricated on a single semiconductor wafer and then separated into individual semiconductor devices.

Metrology processes are used at various steps during a semiconductor manufacturing process to detect defects on wafers to promote higher yield. Optical and x-ray based metrology techniques offer the potential for high throughput without the risk of sample destruction. A number of techniques including scatterometry and reflectometry implementations and associated analysis algorithms are commonly used to characterize critical dimensions, film thicknesses, composition and other parameters of nanoscale structures.

As devices (e.g., logic and memory devices) move toward smaller nanometer-scale dimensions, characterization becomes more difficult. Devices incorporating complex three-dimensional geometry and materials with diverse physical properties contribute to characterization difficulty. In general, semiconductor device shapes and profiles are changing dramatically along with new process capabilities. In particular, advanced logic and memory devices must meet increasingly demanding specifications for Critical Dimension (CD) profiles. Thus, detailed features of geometric profiles must be measured accurately.

Significant advances in process chemistry have enabled new etch applications. In some examples, High Aspect Ratio (HAR) etch tools are capable of etching away very narrow vertical channels in semiconductor die with aspect ratios, i.e., ratio of height/width, of 80:1, or higher. This capability has enabled flash memory architectures to transition from two dimensional floating-gate architectures to fully three dimensional geometries. In some examples, film stacks and etched structures are very deep (e.g., three micrometers in depth, or more) and include an extremely high number of layers (e.g., 400 layers, or more).

As the etch process penetrates deeper into the structure, the etch rate is susceptible to change along the channel. This leads to a non-uniform etch profile, i.e., the Critical Dimension (CD) of a fabricated channel varies as a function of height. Typical semiconductor devices include millions of HAR channels separated from each other by extremely small distances, e.g., tens of nanometers. Thus, etch profile uniformity and parallelism of HAR channels must be controlled to very tight specifications to achieve an acceptable device yield.

High aspect ratio structures create challenges for film and CD measurements. The ability to measure the critical dimensions that define the shapes of holes and trenches of these structures is critical to achieve desired performance levels and device yield. The metrology must be capable of measuring the CD of a continuous profile through a deep channel to determine the location of CD variations and inflection points of profile variations.

In other examples, the most advanced memory and logic device structures, e.g., nanowire structures, forksheet structures, complementary field effect transistor (CFET) structures, multi-deck VNAND structures, etc., incorporate new complex three-dimensional geometry, dramatic topographic changes, and materials with diverse orientation and physical properties. These advanced devices are difficult to characterize.

In response to these challenges, more complex metrology tools have been developed. Measurements are performed over large ranges of several machine parameters (e.g., wavelength, azimuth and angle of incidence, etc.), and often simultaneously. As a result, the measurement time, computation time, and the overall time to generate reliable results, including measurement recipes and accurate measurement models, increases significantly.

Existing physical model based metrology methods typically include a series of steps to model and then measure structure parameters. Typically, measurement data (e.g., DOE spectra) is collected from a set of samples or wafers, a particular metrology target, a testing critical dimension target, an in-cell actual device target, an SRAM memory target, etc. An accurate model of the optical response from these complex structures includes a model of the geometric features, dispersion parameter, and the measurement system is formulated. Typically, a regression is performed to refine the geometric model. In addition, simulation approximations (e.g., slabbing, Rigorous Coupled Wave Analysis (RCWA), etc.) are performed to avoid introducing excessively large errors. Discretization and RCWA parameters are defined. A series of simulations, analysis, and regressions are performed to refine the geometric model and determine which model parameters to float. A library of synthetic spectra is generated. Finally, measurements are performed using the library or regression in real time with the geometric model.

In other examples, machine learning model based metrology methods are employed to perform measurements. In these examples, training data is gathered and employed to train a machine learning based model that maps measured spectra to values of one or more parameters of interest.

In many fabrication scenarios, dimensions measured before and after a particular process step, or set of process steps, are correlated. Thus, in principle, pre-process measurement data may be employed to improve the accuracy of measurements of structures after one or more intervening process steps.

In some examples, pre-process measurement data is employed as part of a physical model based metrology method. In these examples, pre-process measurement data is fed forward to a post-process measurement model. This approach may be employed in a regression based solution using an RCWA solver where all model degrees of freedom are floated simultaneously. In these examples, the pre-process measurement data breaks parameter correlations among multiple interacting model parameters within the post-process measurement model. Unfortunately, RCWA solver based measurement methods have not shown promise for many measurement applications involving the most advanced memory and logic device structures.

Machine learning model based metrology methods have shown greater promise for many measurement applications involving the most advanced memory and logic device structures. However, pre-process measurement data cannot be directly fed forward to a post-process ML based measurement model because each floating parameter is resolved using an independently optimized ML model. Thus, there are no parameter correlations to be broken in an ML based measurement model. As a result, data feedforward of pre-process measurement data does not improve the accuracy of an ML model based measurement.

In general, the effectiveness of a ML based measurement model depends on the quality and quantity of reference training data. Training data must be gathered at high sampling frequency over a wide range of the process parameter space to meet the measurement application requirements involving the most advanced memory and logic device structures. Unfortunately, actual reference measurement data, e.g., Transmission Electron Microscopy (TEM) measurements, Scanning Electron Microscopy (SEM) measurements, etc., is limited to a very small number of measurement sites on a wafer, e.g., less than 50 locations, for a particular measurement application. The lack of accurate reference measurement data collected from each wafer leaves vast portions of the process space unrepresented or underrepresented in the training data set. As a result, a ML based measurement model trained on sparse reference measurement data tends to inaccurately characterize structures fabricated within large portions of the process space.

In an attempt to overcome the lack of actual reference measurement data, training data is generated synthetically. In some examples, post-process synthetic data sets, e.g., spectra, are generated based on a physics based measurement model. The synthetic data sets are generated using an RCWA solver over a range of different parameter values that simulates the process space. The synthetically generated data sets are employed to train a ML based measurement model. In practice, however, synthetically generated training data do not capture all pre-process variation and cannot predict all the possible post-process variation before library generation. In some examples, pre-process variation occurs in parameters that are fixed in value when generating post-process synthetic data sets. As a result, the pre-process variation is not captured at all in the training data. In one example, pre-process process variation of a material optical dispersion occurs, yet the dispersion parameter is treated as fixed when generating post-process synthetic data sets.

In practice, the number of pre-process parameters that can be floated in a physics based measurement model is limited, e.g., 10-15 parameters, by concerns about model quality, time to solution, and the computational effort associated with library generation. Moreover, the number of pre-process parameters that actually vary greatly exceeds that number. As a result, the pre-process variation of many parameters is not captured in the post-process synthetic data sets, even when some pre-process parameters are floated when generating post-process synthetic data sets.

Modeling of emerging semiconductor structures has resulted in increasingly complicated models with unsatisfactory results. Machine learning model based metrology methods have shown promise for many measurement applications involving the most advanced memory and logic device structures. Unfortunately, the training data currently employed to train ML based measurement models is limiting the performance of trained ML based measurement models. In particular, pre-process measurement data that correlates with post-process parameters of interest is not adequately captured by the training data sets currently employed. As complex semiconductor structures become more common, and with less time per project, improved measurement model training methods and tools are desired.

### SUMMARY

Methods and systems for using pre-process measurement data to train a post-process, machine learning (ML) based measurement model are described herein. In addition, methods and systems for performing measurements of complex semiconductor structures based on a combined measurement model including trained pre-process and post-process measurement models are also described herein. Pre-process measurement data is employed directly as part of a combined ML based measurement, indirectly as part of the training data set for a post-process, ML based measurement model, or both, to take advantage of the correlation between structural characteristics of a measured sample before and after one or more intervening process steps.

The methods and systems described herein improve measurement accuracy and robustness for cutting-edge measurement applications involving Gate All Around (GAA) structures, Fork Sheet structures, CFET structures, 3D VNAND structures, 3D DRAM structures, etc. In one example, the methods and systems described herein improve critical dimension measurements of a GAA SRAM structure after a Sheet Formation process step.

In one aspect, a post-process, ML based measurement model is trained using reference data derived from actual reference measurements and estimated reference data generated by a trained mapping model. The trained mapping model maps measured values of parameters of interest at a pre-process state to estimated reference values at the post-process state. In this manner, the reference data employed to train a ML based measurement model is augmented based on pre-process measurement data.

The measured values of parameters of interest at the pre-process state are reliably generated by high-throughput, in-line metrology. By augmenting actual reference measurements with estimated reference data generated at high-throughput, a very large, high quality reference data set is generated quickly and at reasonable cost in terms of time and effort.

For many process steps of a complex semiconductor structure, reliable reference measurements are only available from low throughput, expensive, and often destructive measurement techniques, e.g., Transmission Election Microscopy (TEM), Scanning Electron Microscopy (SEM), etc. Thus, in practice, it is not feasible to generate very large reference data sets based on actual reference measurement data generated by trustworthy reference measurement systems for many process steps. In response, pre-process measurement data is employed to overcome the limited amount of actual reference measurement data.

Measurements of parameters of interest at a post-process state using a post-process measurement model trained using augmented reference data are generally more robust and more accurate compared to measurements performed using a post-process measurement model trained using only actual reference data. Moreover, training a post-process, ML based measurement model using actual reference data augmented by estimated reference data generated by a trained mapping model dramatically shortens the time required to generate an accurate and reliable machine learning based measurement model.

In some embodiments, a post-process measurement model is trained using only the augmented reference data. In other embodiments, a post-process measurement model is trained based on both augmented reference data and actual reference data. In some of these embodiments, different weights are applied to augmented reference data versus actual reference data during post-process measurement model training. In some examples, the relative weighting depends on the goodness of fit, e.g., R² value, associated with the trained mapping model employed to model the relationship between pre-process measurement values and corresponding post-process measurement values. If the goodness of fit is relatively high, the weighting value associated with the augmented reference data set is assigned a value relatively close to the weighting value associated with the actual reference data set. If the goodness of fit is relatively low, the weighting value associated with the augmented reference data set is assigned a value significantly lower than the weighting value associated with the actual reference data set to de-emphasize the augmented reference data set relative to the actual reference data set.

In another aspect, measurements of complex semiconductor structures are based on a combined measurement model including trained pre-process and post-process measurement models. Pre-process measurement data is employed directly as part of a combined ML based measurement and indirectly as part of the training data set for the combined ML based measurement model to take advantage of the correlation between structural characteristics of a measured sample before and after one or more intervening process steps.

In a further aspect, dimensions of a sample in a post-process state are determined by providing measurement data at one or more pre-process states and the post-process state as input to a combined ML based measurement model. The combined ML based measurement model is a machine learning based measurement model that determines dimensions of a sample based on measurement data provided as input to the model.

In a further aspect, a combined ML based measurement model is trained based at least in part on augmented reference data and raw measurement signals collected from a structure under measurement at one or more pre-process states and a post-process state. The trained combined ML based measurement model includes a combination of two trained machine learning based measurement models and a trained machine learning based weighing model that determines dimensions of a sample based on measurement data collected at both a pre-process state and a post-process state.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a diagram illustrative of an embodiment of a spectroscopic ellipsometry system for measuring characteristics of a semiconductor wafer based on augmented reference measurement data as described herein.

FIG. 2 is a diagram illustrative of a post-process measurement engine 170 configured to estimate values of one or more parameters of interest characterizing a semiconductor structure in a post-process state as described herein.

FIG. 3 is a diagram illustrative of a post-process measurement model training engine 160 configured to train a post-process measurement model as described herein.

FIG. 4 is a diagram illustrative of a mapping model training engine 150 configured to train a mapping model as described herein.

FIG. 5 is a diagram illustrative of a nanowire based semiconductor structure in one embodiment.

FIG. 6 is a diagram illustrative of a nanosheet based semiconductor structure in a pre-process state in one embodiment.

FIG. 7 is a diagram illustrative of the nanosheet based semiconductor structure depicted in FIG. 6 in a post-process state in one embodiment.

FIG. 8 is a plot illustrative of correlation between the width of inner spacer structures immediately after the epitaxial growth step and immediately after the SiGe release step.

FIG. 9 is a plot illustrative of correlation between the critical dimension, MGCD₁, depicted in FIG. 7 immediately after the epitaxial growth step and immediately after the SiGe release step.

FIG. 10 is a plot illustrative of correlation between the critical dimension, MGCD₂, depicted in FIG. 7, immediately after the epitaxial growth step and immediately after the SiGe release step.

FIG. 11 is a plot illustrative of correlation between the critical dimension, MGCD₃, depicted in FIG. 7, immediately after the epitaxial growth step and immediately after the SiGe release step.

FIG. 12 is a plot indicating an exemplary correlation between measured values of a parameter of interest characterizing a number of instances of a structure in a pre-process state and corresponding reference measurement values of a parameter of interest characterizing the same instances of the structure in a post-process state.

FIG. 13 is a plot indicating the quality of fit between estimated post-process values of MGCD₂ using the mapping function described with reference to FIG. 12 and actual reference values of MGCD₂.

FIG. 14 is a plot indicating an exemplary correlation between values of MGCD₂ estimated by a trained post-process measurement model as described herein and values of SiGe recess reliably measured in a pre-process state in one example.

FIG. 15 is a plot indicating an exemplary correlation between values of MGCD₂ estimated by a trained post-process measurement model as described herein and values of SiGe recess reliably measured in a pre-process state in another example.

FIG. 16 is a diagram illustrative of a combined ML based measurement engine 240 configured to estimate values of one or more parameters of interest characterizing a semiconductor structure in a post-process state as described herein.

FIG. 17 is a diagram illustrative of a combined ML based measurement model training engine 250 configured to train a combined ML based measurement model as described herein.

FIG. 18 illustrates a method 400 for training a post-process measurement model as described herein.

FIG. 19 illustrates a method 500 for measuring semiconductor structures based on a trained combined ML based measurement model as described herein.

### DETAILED DESCRIPTION

Reference will now be made in detail to background examples and some embodiments of the invention, examples of which are illustrated in the accompanying drawings.

Methods and systems for using pre-process measurement data to train a post-process, machine learning (ML) based measurement model are described herein. In addition, methods and systems for performing measurements of complex semiconductor structures based on a combined measurement model including trained pre-process and post-process measurement models are also described herein. Pre-process measurement data is employed directly as part of a combined ML based measurement, indirectly as part of the training data set for a post-process, ML based measurement model, or both, to take advantage of the correlation between structural characteristics of a measured sample before and after one or more intervening process steps.

The methods and systems described herein improve measurement accuracy and robustness for cutting-edge measurement applications involving Gate All Around (GAA) structures, Fork Sheet structures, CFET structures, 3D VNAND structures, 3D DRAM structures, etc. In one example, the methods and systems described herein improve critical dimension measurements of a GAA SRAM structure after a Sheet Formation process step.

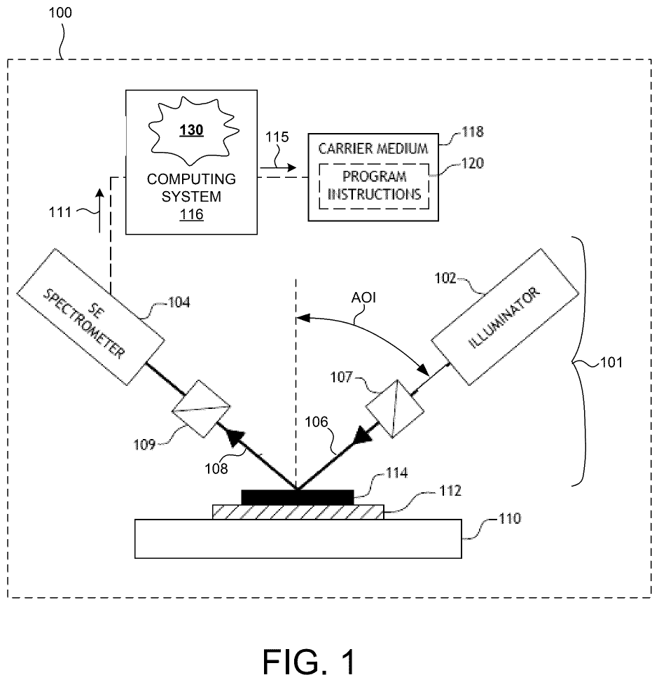

FIG. 1 illustrates a system 100 for measuring characteristics of a semiconductor wafer. As shown in FIG. 1, system 100 may be used to perform spectroscopic ellipsometry measurements of one or more structures 114 of a semiconductor wafer 112 disposed on a wafer positioning system 110. In this aspect, the system 100 may include a spectroscopic ellipsometer equipped with an illuminator 102 and a spectrometer 104. The illuminator 102 of the system 100 is configured to generate and direct illumination of a selected wavelength range (e.g., 150-4500 nm) to the structure 114 disposed on the surface of the semiconductor wafer 112. In turn, the spectrometer 104 is configured to receive light from the surface of the semiconductor wafer 112. It is further noted that the light emerging from the illuminator 102 is polarized using a polarization state generator 107 to produce a polarized illumination beam 106. The radiation reflected by the structure 114 disposed on the wafer 112 is passed through a polarization state analyzer 109 and to the spectrometer 104. The radiation received by a detector of spectrometer 104 in the collection beam 108 is analyzed with regard to polarization state, allowing for spectral analysis of radiation passed by the analyzer. These spectra 111 are passed to the computing system 116 for analysis of the structure 114.

In a further embodiment, the metrology system 100 is a measurement system 100 that includes one or more computing systems 116 configured to execute post-process measurement tool 170 in accordance with the description provided herein. In the preferred embodiment, post-process measurement tool 170 is a set of program instructions 120 stored on a carrier medium 118. The program instructions 120 stored on the carrier medium 118 are read and executed by computing system 116 to realize model based measurement functionality as described herein. The one or more computing systems 116 may be communicatively coupled to the spectrometer 104. In one aspect, the one or more computing systems 116 are configured to receive measurement data 111 associated with a measurement (e.g., critical dimension, film thickness, composition, process, etc.) of the structure 114 of specimen 112. In one example, the measurement data 111 includes an indication of the measured spectral response (e.g., measured intensity as a function of wavelength) of the specimen by measurement system 100 based on the one or more sampling processes from the spectrometer 104. In some embodiments, the one or more computing systems 116 are further configured to determine specimen parameter values of structure 114 from measurement data 111.

In a further aspect, computing system 116 is configured to determine dimensions of a sample by providing measurement data 111 as input to a trained post process measurement model. The trained post process measurement model is a machine learning based measurement model that determines dimensions of a sample based on measurement data provided as input to the model.

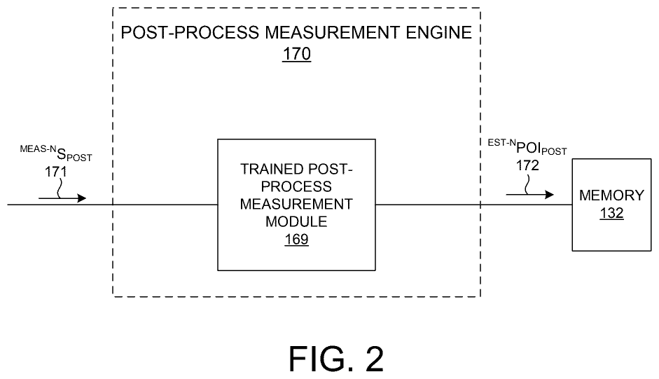

In the embodiment depicted in FIG. 2, computing system 116 is configured as a post-process measurement engine 170 configured to implement model based measurement functionality as described herein. As depicted in FIG. 2, post-process measurement engine 170 includes a trained, post-process measurement module 169. Trained post-process measurement module 169 includes a trained post-process measurement model that generates estimated values of one or more parameters of interest, ^{EST-N}POI_{POST} 172, characterizing the shape of a structure under measurement in a post-process state, i.e., after a particular process step, based on spectral measurements, ^{MEAS-N}S_{POST} 171. In one example, measurements are performed at N different instances of a semiconductor structure fabricated at different locations, different wafers, or both, where N is any positive integer value. Specimen parameters of interest can be deterministic (e.g., CD, SWA, etc.) or statistical (e.g., rms height of sidewall roughness, roughness correlation length, etc.).

In some embodiments, measurement system 100 is further configured to store one or more trained post-process measurement models in a memory (e.g., carrier medium 118).

In one aspect, a post-process, ML based measurement model is trained using reference data derived from actual reference measurements and estimated reference data generated by a trained mapping model. The trained mapping model maps measured values of parameters of interest at a pre-process state to estimated reference values at the post-process state. In this manner, the reference data employed to train a ML based measurement model is augmented based on pre-process measurement data.

The measured values of parameters of interest at the pre-process state are reliably generated by high-throughput, in-line metrology. By augmenting actual reference measurements with estimated reference data generated at high-throughput, a very large, high quality reference data set is generated quickly and at reasonable cost in terms of time and effort.

For many process steps of a complex semiconductor structure, reliable, actual reference measurements are only available from low throughput, expensive, and often destructive measurement techniques, e.g., Transmission Election Microscopy (TEM), Scanning Electron Microscopy (SEM), etc. Thus, in practice, it is not feasible to generate very large reference data sets based on actual reference measurement data generated by trustworthy reference measurement systems for many process steps. In response, pre-process measurement data is employed to overcome the lack of actual reference measurement data collected at a limited number of different locations on a limited number of different wafers.

Measurements of parameters of interest at a post-process state using a post-process measurement model trained using augmented reference data are generally more robust and more accurate compared to measurements performed using a post-process measurement model trained using only actual reference data.

Training a post-process, ML based measurement model using actual reference data augmented by estimated reference data generated by a trained mapping model dramatically shortens the time required to generate an accurate and reliable measurement model.

In general, to accurately map measured values of parameters of interest at a pre-process state to estimated reference values at a post-process state, there must be a process correlation between the parameters of interest in the pre-process state and the parameters of interest in the post-process state, and this correlation must be captured by the high-throughput measurement signals, e.g., measured spectra, captured at the pre-process and post-process states. In this manner, process correlation between steps enables improved solution accuracy and robustness.

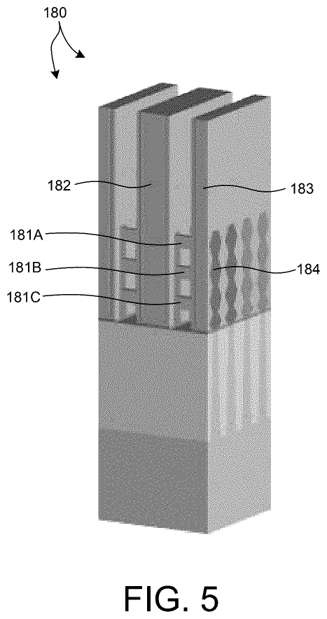

FIG. 5 depicts a nanowire based semiconductor structure 180. Structure 180 includes nanowires 181A-C, source/drain structures 182 and 183, and dielectric material 184. As illustrated in FIG. 5, nanowires 181A-C extend unsupported between source/drain structures 182 and 183. As a result, there are voids between adjacent nanowires.

The shape of a nanowire or nanosheet affects device performance significantly. Furthermore, the shape of a nanowire or nanosheet can change from one process step to another. In one example, sacrificial Silicon Germanium sheets are removed at the nanosheet release step. In addition to the removal of the SiGe sheets, part of the interspaced Silicon layers is consumed by the Silicon Germanium removal process, and as a result, the height of the Silicon nanosheets is also reduced during the release step. This can lead to height non-uniformity among Silicon nanosheets. In addition, the underlying Silicon nanosheets are affected by various etch recipes prior to the nanosheet release step.

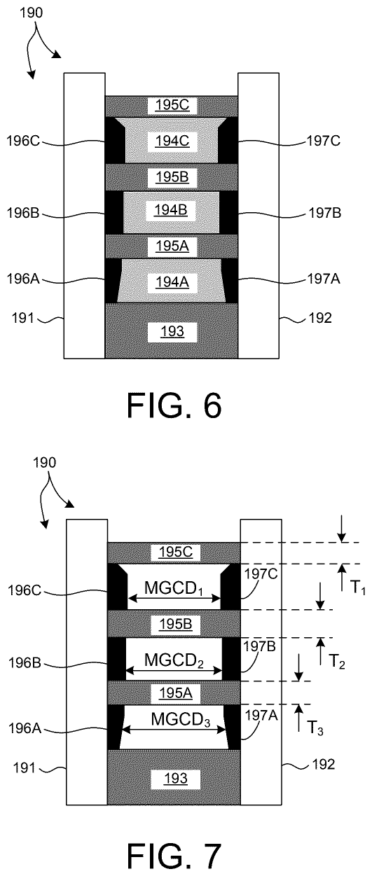

FIG. 6 is a simplified diagram illustrative of a nanosheet structure in pre-process state before the Silicon Germanium (SiGe) release step. As depicted in FIG. 6, nanosheet based semiconductor structure 190 includes a SiGe source structure 191, a SiGe drain structure 192, a silicon substrate 193, and stacked Silicon nanosheet structures 195A-C. In addition, nanosheet based semiconductor structure 190 includes inner spacer structures 196A-C attached to SiGe source structure 191 and inner spacer structures 197A-C attached to SiGe drain structure 192. Inner spacer structures 196A-C and 197A-C are located below silicon nanosheet structures 195A-C, respectively. Finally, SiGe material occupies the spaces 194A-194C between silicon substrate 193 and silicon nanosheets 195A-C, respectively. Furthermore, spaces 194A-194C are bounded by inner spacer structures 196A-C and 197A-C, respectively.

FIG. 7 is a simplified diagram illustrative of the nanosheet structure depicted in FIG. 6 in a post-process state after the SiGe release step. As depicted in FIG. 7, at the SiGe release step, the SiGe material occupying the spaces 194A-194C between silicon substrate 193 and silicon nanosheets 195A-C, respectively, is etched away. Several geometric parameters are critical at the post-process state after the SiGe release step. Exemplary critical parameters include the metal gate critical dimensions associated with each nanosheet, e.g., MGCD₁-MGCD₃, the thickness associated with each nanosheet, e.g., T₁-T₃, the shape profile of the inner spacers, the width of each nanosheet, the shape profile of each nanosheet, etc. Independent measurement of these dimensions and shape profiles is very challenging given the complexity of the structures and the relatively low volume of the critical dimensions and features.

The critical dimensions and features depicted in FIG. 7 are partially formed at the SiGe release step. However, in addition, the critical dimensions and features depicted in FIG. 7, strongly depend on previous process steps as well. In one example, the inner spacer structures are deposited and then trimmed at various epitaxial growth and strained source drain (SSD) process steps, prior the SiGe release step. In addition, a portion of the inner spacer structures is etched away at the SiGe release step. Thus, the width dimension of the inner spacer structure depends on the inner spacer dimensions at one or more pre-process steps, e.g., at the inner spacer deposition and inner spacer trim steps, in addition to SiGe release step.

In one example, process correlation from a pre-process state to a post-process state exists for inner spacer width between an epitaxial growth step employed to from the SiGe source and drain structures 191 and 192 (pre-process state) and the subsequent SiGe release step (post-process state).

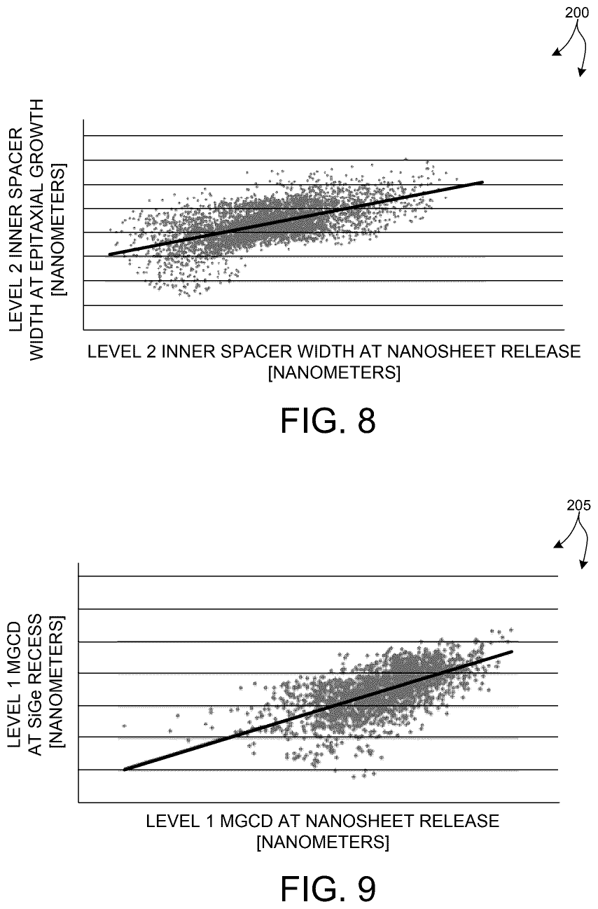

FIG. 8 is a plot 200 illustrative of correlation between the width of inner spacer structures immediately after the epitaxial growth step and immediately after the SiGe release step. As depicted in FIG. 8, the inner spacer width measured in the pre-process state is plotted along the y-axis and same dimension measured in the post-process state is plotted along the x-axis. As illustrated in FIG. 8, the correlation between the inner spacer width measured at the pre-process state and the post-process state is significant, having an R² value of 0.5 recorded on 5,000 samples.

In another example, process correlation from a pre-process state to a post-process state exists for the dimension MGCD₁ depicted in FIG. 7 between an epitaxial growth step employed to form the SiGe source and drain structures 191 and 192 (pre-process state) and the subsequent SiGe release step (post-process state).

FIG. 9 is a plot 205 illustrative of correlation between the critical dimension, MGCD₁, depicted in FIG. 7 immediately after the epitaxial growth step and immediately after the SiGe release step. As depicted in FIG. 9, MGCD₁ measured in the pre-process state is plotted along the y-axis and same dimension measured in the post-process state is plotted along the x-axis. As illustrated in FIG. 9, the correlation between MGCD₁ measured at the pre-process state and the post-process state is significant, having an R² value of 0.40 recorded on 5,000 samples.

In another example, process correlation from a pre-process state to a post-process state exists for the metal gate critical dimension, MGCD₂, depicted in FIG. 7 between an epitaxial growth step employed to form the SiGe source and drain structures 191 and 192 (pre-process state) and the subsequent SiGe release step (post-process state).

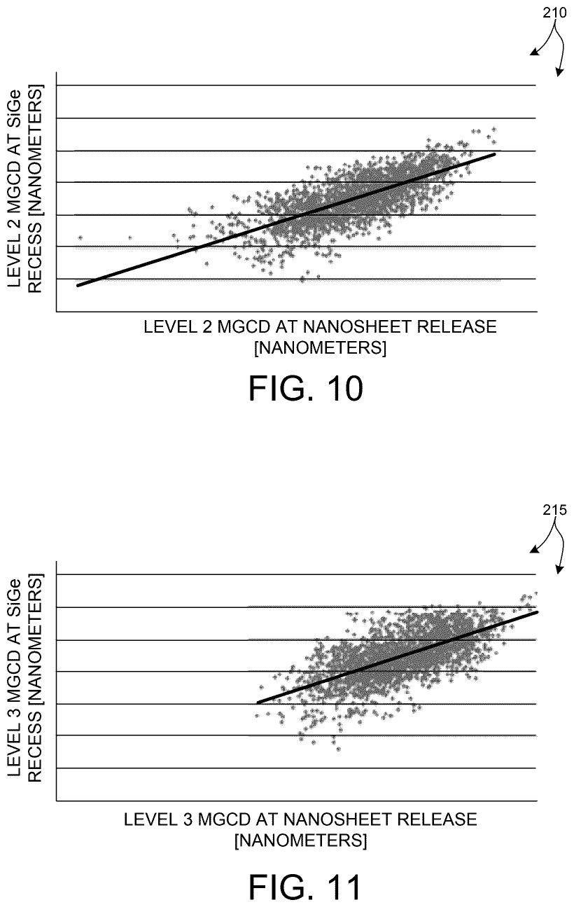

FIG. 10 is a plot 210 illustrative of correlation between the critical dimension, MGCD₂, immediately after the epitaxial growth step and immediately after the SiGe release step. As depicted in FIG. 10, MGCD₂ measured in the pre-process state is plotted along the y-axis and same dimension measured in the post-process state is plotted along the x-axis. As illustrated in FIG. 10, the correlation between MGCD₂ measured at the pre-process state and the post-process state is significant, having an R² value of 0.53 recorded on 5,000 samples.

In another example, process correlation from a pre-process state to a post-process state exists for the metal gate critical dimension, MGCD₃, depicted in FIG. 7 between an epitaxial growth step employed to form the SiGe source and drain structures 191 and 192 (pre-process state) and the subsequent SiGe release step (post-process state).

FIG. 11 is a plot 215 illustrative of correlation between the critical dimension, MGCD₃, immediately after the epitaxial growth step and immediately after the SiGe release step. As depicted in FIG. 11, MGCD₃ measured in the pre-process state is plotted along the y-axis and same dimension measured in the post-process state is plotted along the x-axis. As illustrated in FIG. 11, the correlation between MGCD₃ measured at the pre-process state and the post-process state is significant, having an R² value of 0.43 recorded on 5,000 samples.

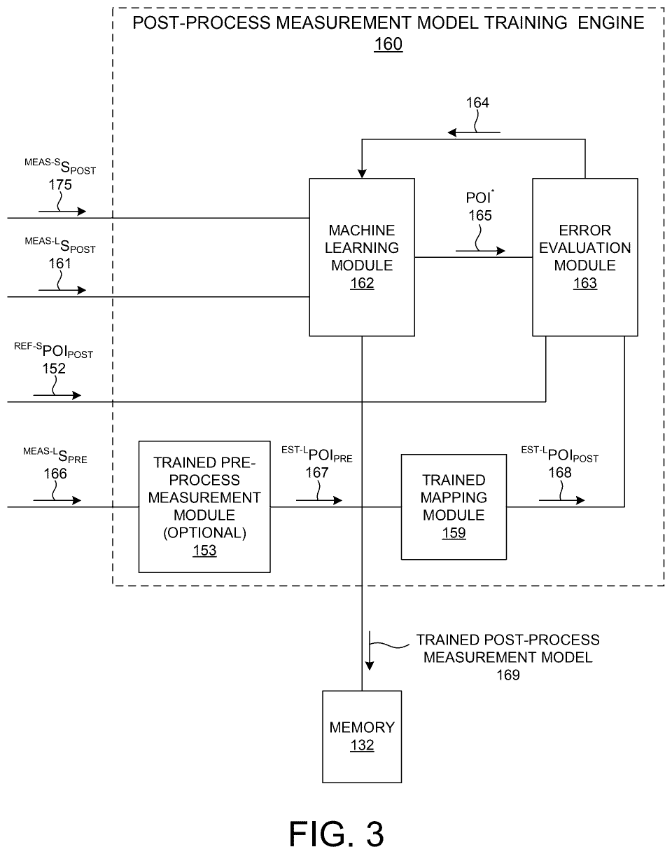

In a further aspect, computing system 116 is configured to train a post-process measurement model based at least in part on augmented reference data. The trained post process measurement model is a machine learning based measurement model that determines dimensions of a sample based on measurement data provided as input to the model. In the embodiment depicted in FIG. 3, computing system 116 is configured as a post-process measurement training engine 160.

FIG. 3 is a diagram illustrative of an exemplary post-process measurement model training engine 160 implemented by computing system 116. As depicted in FIG. 3, post-process measurement model training engine 160 includes a machine learning module 162, an error evaluation module 163, a trained mapping module 159, and, optionally, a trained pre-process measurement module 153.

As depicted in FIG. 3, trained pre-process measurement module 153 receives measurement signals, ^{MEAS-L}S_{PRE} 166, indicative of measurement signals derived from measurements of L instances of a structure fabricated at many different wafer locations on many different wafers in a pre-process state, where L is a large, positive integer number. ^{MEAS-L}S_{PRE} 166 is typically a very large data set collected using one or more instances of a high-throughput measurement system, e.g., a high-throughput optical critical dimension (OCD) measurement system such as the spectroscopic ellipsometry system depicted in FIG. 1. In general, however, any suitable high-throughput measurement system may be employed to collect measurement signals ^{MEAS-L}S_{PRE} 166.

As depicted in FIG. 3, pre-process measurement signals ^{MEAS-L}S_{PRE} 166 are communicated to a trained pre-process measurement module 153. The trained pre-process measurement module 153 includes a pre-process measurement model employed to estimate values of one or more parameters of interest, ^{EST-L}POI_{PRE} 167, characterizing the measured structure in the pre-process state at each of the different measurement locations and different wafers based on the corresponding pre-process measurement signals, ^{MEAS-L}S_{PRE} 166.

In some examples, the pre-process measurement model is a trained machine learning based pre-process measurement model that has been tested and validated for accuracy and robustness. In these examples, the ML based pre-process measurement model is trained based on reference data collected from DOE wafers in the pre-process state. The trained ML based pre-process measurement model directly generates estimated values of one or more parameters of interest, ^{EST-L}POI_{PRE} 167, characterizing the measured structure in the pre-process state at each of the different measurement locations and different wafers based on the corresponding pre-process measurement signals, ^{MEAS-L}S_{PRE} 166.

In some other examples, the pre-process measurement model is a trained, physics-based measurement model that has been tested and validated for accuracy and robustness.

In these examples, the metrology involves determining the dimensions of the sample by iterative comparison between the measured data, e.g., optical scatterometry signals, optical ellipsometry signals, x-ray scatterometry signals, etc., and the inverse solution of the physics-based measurement model for assumed values of the one or more parameters of interest. The measurement model includes a few (on the order of ten) adjustable parameters and is representative of the geometry and optical properties of the specimen and the optical properties of the measurement system. The method of inverse solve includes, but is not limited to, model based regression, tomography, machine learning, or any combination thereof. In this manner, values of pre-process parameters of interest are estimated by solving for values of a parameterized measurement model that minimize errors between the measured signals and modeled signals.

In these examples, parameters of the physics-based pre-process measurement model are tuned based on reference data collected from DOE wafers in the pre-process state. In this manner, the trained physics-based based pre-process measurement model generates estimated values of one or more parameters of interest, ^{EST-L}POI_{PRE} 167, characterizing the measured structure in the pre-process state at each of the different measurement locations and different wafers based on the corresponding pre-process measurement signals, ^{MEAS-L}S_{PRE} 166.

In general, the trained pre-process measurement model is trained based on known techniques. In some examples, the trained pre-process measurement model may be integrated as part of the post-process measurement model training engine 160 as depicted in FIG. 3. However, in other examples, the trained pre-process measurement model is not integrated with post-process measurement model training engine 160. In these examples, the estimated values of one or more parameters of interest, ^{EST-L}POI_{PRE} 167, are provided directly as input to post-process measurement model training engine 160.

As depicted in FIG. 3, the estimated values of one or more parameters of interest, ^{EST-L}POI_{PRE} 167, are communicated to trained mapping module 159. Trained mapping module 159 includes a trained mathematical function, e.g., trained linear function, trained non-linear function, etc., that maps each estimated value of each parameter of interest at each different measurement location and different wafer in the pre-process state to corresponding estimated values, ^{EST-L}POI_{POST} 168, of each parameter of interest at each different measurement location and different wafer in the post-process state. ^{EST-L}POI_{POST} 168 are communicated to error evaluation module 163 as augmented reference data for training of the post-process measurement model.

In addition, machine learning module 162 receives post-process measurement signals, ^{MEAS-L}S_{POST} 161, indicative of measurement signals derived from measurements of the many instances of the structure fabricated at many different wafer locations on different wafers corresponding with the pre-process measurement signals, ^{MEAS-L}S_{PRE} 166, but this time in a post-process state. Typically, ^{MEAS-L}S_{POST} 161 is a very large data set collected using one or more instances of a high-throughput measurement system, e.g., a high-throughput optical critical dimension (OCD) measurement system such as the spectroscopic ellipsometry system depicted in FIG. 1. In general, however, any suitable high-throughput measurement system may be employed to collect measurement signals ^{MEAS-L}S_{POST} 161.

In some examples, machine learning module 162 generates estimated values of one or more parameters of interest, POI* 165, based on each set of measurement signals comprising ^{MEAS-L}S_{POST} 161. Error evaluation module 163 receives the estimated values of the one or more parameters of interest, POI* 165, generated by machine learning module 162. In addition, error evaluation module 163 receives the values of the augmented reference measurement signals, ^{EST-L}POI_{POST} 168 associated with each set of measurement signals. The values of the augmented reference measurement signals, ^{EST-L}POI_{POST} 168 indicate trusted values of the one or more parameters of interest associated with each set of measurement signals. Error evaluation module 163 generates updated values of weighting parameters 164 of the machine learning model 162 undergoing training to minimize differences between the estimated values of the one or more parameters of interest, POI* 165, and the trusted values of the one or more parameters of interest associated with each set of measurement signals, ^{EST-L}POI_{POST} 168. In the next iteration of model training, new estimated values of the one or more parameters of interest, POI* 165, are generated by machine learning module 162 based on the values of the weighting parameters 164 generated in the previous iteration. The training process continues until the differences between the estimated values of the one or more parameters of interest, POI* 165, and the trusted values of the one or more parameters of interest associated with each set of measurement signals, ^{EST-L}POI_{POST} 168 are acceptably small. At this point, the trained post-process measurement model 169 is stored in a memory, e.g., memory 132.

As depicted in FIG. 3, the post-process measurement model training engine 160 employs the mapping module 159 to generate a large set of augmented reference measurement data to train the post-process measurement model. The augmented reference measurement data is based on reliable, high-throughput measurements of a large number of instances of a structure of interest at a pre-process state. The trained mapping module 159 maps the pre-process measurement results to estimated values of one or more parameters of interest in the post-process state. This enables training with a large post-process reference data set that would otherwise be impractical to generate based on actual reference measurements in the post-process state.

In some examples, augmented reference measurement data continues to be generated based on reliable, high-throughput, in-line measurements of a continuously growing number of instances of a structure of interest at one or more pre-process states, e.g., ^{EST-L}POI_{PRE} 167, along with corresponding high-throughput, in-line measurement signals in the post-process state, e.g., ^{MEAS-L}S_{POST} 161. In these examples, pre-process and post-process measurements continue to be collected from in-line, production wafers. As described hereinbefore, the pre-process measurements are communicated to trained mapping module 159 to generate additional augmented reference measurement data, ^{EST-L}POI_{POST} 168, and the corresponding post-process measurement signals, ^{MEAS-L}POI_{POST} 161, are communicated to machine learning module 162. Periodically, the expanded set of training data is employed to retrain the post-process measurement model to continuously improve the accuracy and reliability of the trained post-process measurement model as production continues.

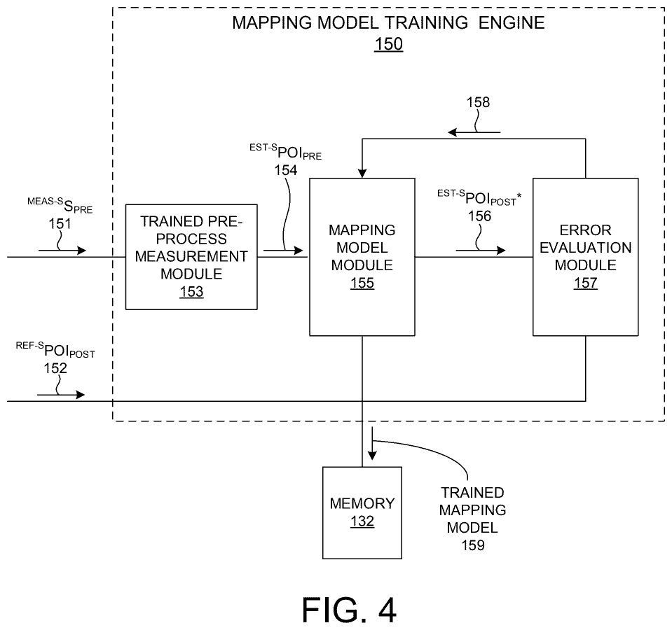

In a further aspect, computing system 116 is configured to train a mapping model based on actual reference data. The trained mapping model determines the values of one or more parameters of interest characterizing a structure in a post-process state based on values of one or more parameters of interest characterizing the structure in one or more pre-process states as measured by a reference measurement system. In some embodiments the one or more parameters of interest characterizing the structure in a post-process state are the same parameters characterizing the structure in a pre-process state. However, in general, the one or more parameters of interest characterizing the structure in a post-process state may be different from the parameters characterizing the structure in a pre-process state. In the embodiment depicted in FIG. 4, computing system 116 is configured as a mapping model training engine 150.

FIG. 4 is a diagram illustrative of an exemplary mapping model training engine 150 implemented by computing system 116. As depicted in FIG. 4, mapping model training engine 150 includes a mapping model module 155, an error evaluation module 157, and, optionally, a trained pre-process measurement module 153.

As depicted in FIG. 4, trained pre-process measurement module 153 receives measurement signals, ^{MEAS-S}S_{PRE} 151, indicative of measurement signals derived from measurements of S instances of a structure fabricated at different wafer locations on one or more different wafers in a pre-process state, where S is a positive integer number, typically much smaller than L.

The trained pre-process measurement module 153 includes a pre-process measurement model employed to estimate values of one or more parameters of interest, ^{EST-S}POI_{PRE} 154, characterizing the measured structure in the pre-process state at each of the different measurement locations on one or more different wafers based on the corresponding pre-process measurement signals, ^{MEAS-S}S_{PRE} 151.

In general, the trained pre-process measurement model is trained based on known techniques. In some examples, the trained pre-process measurement model may be integrated as part of the mapping model training engine 150 as depicted in FIG. 4. However, in other examples, the trained pre-process measurement model is not integrated with mapping model training engine 150. In these examples, the estimated values of one or more parameters of interest, ^{EST-S}POI_{PRE} 154, are provided directly as input to mapping model training engine 150.

As depicted in FIG. 4, the estimated values of one or more parameters of interest, ^{EST-S}POI_{PRE} 154, are communicated to mapping model module 155. In addition, error evaluation module 157 receives actual reference measurement signals, ^{REF-S}POI_{POST} 152, indicative of the values of the instances of the structure fabricated at different wafer locations on one to more different wafers corresponding with the pre-process measurement signals, ^{MEAS-S}S_{PRE} 151, but this time in a post-process state. Typically, ^{REF-S}POI_{POST} 152 is a relatively small data set, i.e., much smaller than the augmented reference data set ^{EST-L}POI_{POST} 168. Typically, the actual reference measurements are performed by low-throughput reference measurement techniques that in many cases are also destructive to the sample under measurement. Exemplary reference measurement systems include transmission electron microscopy (TEM) systems, critical dimension scanning electron microscopy (CD-SEM) systems, atomic force microscopy (AFM) systems, etc. In general, however, any suitable trusted, reference measurement system may be employed to collect measurement signals ^{REF-S}POI_{POST} 152.

Mapping model module 155 includes a mapping function, i.e., a parameterized mathematical function, that maps each measured value of a parameter of interest comprising ^{EST-S}POI_{PRE} 154 to corresponding estimated values of one or more parameters of interest, ^{EST-S}POI_{POST}* 156, in a post-process state. The parameterized mathematical function may be a linear function, a non-linear function, etc. In general, the parameterized mathematical function may be any suitable mathematical function. Error evaluation module 157 receives the estimated values of the one or more parameters of interest, ^{EST-S}POI_{POST}* 156, generated by mapping model module 155, and compares the estimated values to the corresponding actual reference measurement values, ^{REF-S}POI_{POST} 152. The values of the actual reference measurement values, ^{REF-S}POI_{POST} 152 are trusted values of the one or more parameters of interest associated with each measurement in the post-process state. Error evaluation module 157 generates updated values of parameters 158 of the mapping model undergoing training to minimize differences between the estimated values of the one or more parameters of interest, ^{EST-S}POI_{POST} 156, and the actual reference values of the one or more parameters of interest associated with each measurement, ^{REF-S}POI_{POST} 152.

In the next iteration of model training, new estimated values of the one or more parameters of interest, ^{EST-S}POI_{POST}* 156, are generated by mapping model module 155 based on the values of the weighting parameters 158 generated in the previous iteration. The training process continues until the differences between the estimated values of the one or more parameters of interest, ^{EST-S}POI_{POST}* 156, and the actual values of the one or more parameters of interest associated with each reference measurement, ^{REF-S}POI_{POST} 152, are acceptably small. At this point, the trained mapping model 159 is stored in a memory, e.g., memory 132.

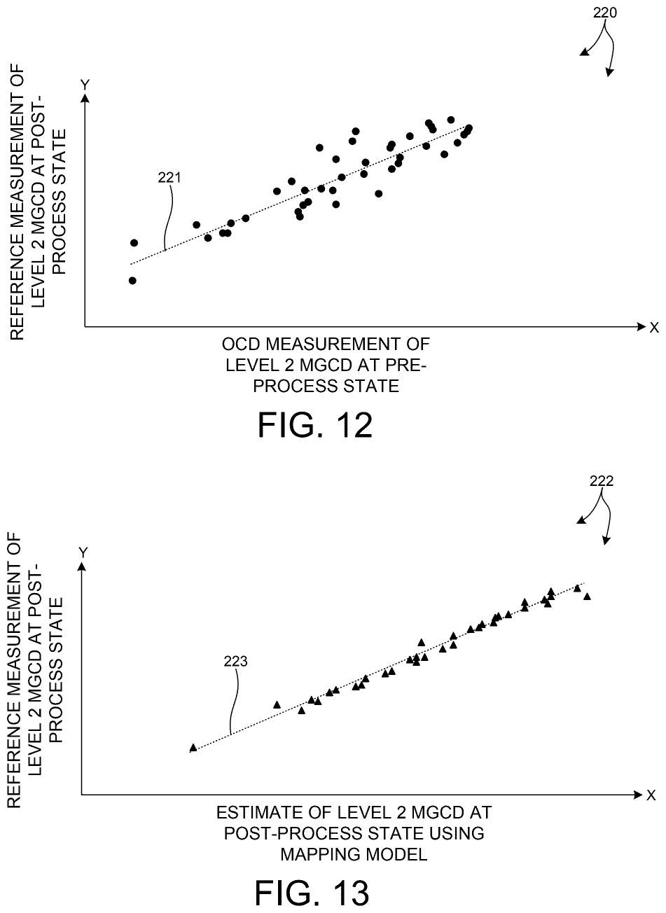

FIG. 12 is a plot 220 indicating an exemplary correlation between measured values of a parameter of interest characterizing a number of instances of a structure in a pre-process state and corresponding reference measurement values of a parameter of interest characterizing the same instances of the structure in a post-process state. In the example depicted in FIG. 12, the structure under reference measurement is the level 2 metal gate critical dimension (MGCD₂) depicted in FIG. 7. Each instance is indicated by a black dot in plot 220. The y-coordinate associated with each instance corresponds to the measured value of MGCD₂ in a post-process state by a reference measurement system, e.g., a TEM tool. In this example, the post-process state is immediately after the SiGe release step. The x-coordinate associated with each instance corresponds to the measured value of the level 2 silicon Germanium Recess dimension in a pre-process state, i.e., before the SiGe release step by an in-line metrology system, e.g., an optical critical dimension (OCD) tool. The linear function 221 describes a mathematical relationship between the pre-process OCD measurements of the SiGe recess and the post-process TEM measurements of MGCD₂. In this example, the mathematical relationship is described by the mathematical equation, y=0.978x+1.92. In this example, the mathematical equation is the mapping model employed to map pre-process OCD measurements of the SiGe recess to estimated post-process values of MGCD₂.

FIG. 13 is a plot 222 indicating the quality of fit between estimated post-process values of MGCD₂ using the mapping function described with reference to FIG. 12 and actual reference values of MGCD₂. In the example depicted in FIG. 13, the structure under reference measurement is the level 2 metal gate critical dimension (MGCD₂) depicted in FIG. 7. Each instance is indicated by a black triangle in plot 222. The y-coordinate associated with each instance corresponds to the measured value of MGCD₂ in a post-process state by a reference measurement system, e.g., a TEM tool. In this example, the post-process state is immediately after the SiGe release step. The x-coordinate associated with each instance corresponds to the estimated value of MGCD₂ at the post-process state based on the mapping model described with reference to FIG. 12. As depicted in FIG. 13, linear function 223 describes a linear fit between the reference values and estimated values of MGCD₂. The R² value associated with the linear fit is 0.98, thus indicating an excellent fit between the actual reference data and the augmented reference data generated by the mapping model. In this example, the mapping model enables generation of a large quantity of reference data based on high-throughput measurements a pre-process state without significant sacrifice of accuracy and reliability.

In a further aspect, a post-process measurement model is trained based on both augmented reference data and actual reference data. As described hereinbefore with reference to FIG. 3, error evaluation module 163 receives the augmented reference measurement values, ^{EST-L}POI_{POST} 168. In some embodiments, a post-process measurement model is trained using only the augmented reference data. However, in some other embodiments, error evaluation module 163 receives both the augmented reference measurement values, ^{EST-L}POI_{POST} 168 and actual reference measurement signals ^{REF-S}POI_{POST} 152. In addition, in these embodiments, machine learning module 162 receives post-process measurement signals, ^{MEAS-S}S_{POST} 175, generated by a high-throughput measurement system associated with measurements of the instances of the structure subject to actual reference measurements. Thus, in these embodiments, the post-process measurement model training engine 160 is training the post-process measurement model based on actual, post-process reference measurement values, ^{REF-S}POI_{POST} 152, and corresponding measurement signals associated with measurement of the reference structures by a high-throughput measurement system, ^{MEAS-S}S_{POST} 175, along with augmented, post-process reference measurement values, ^{EST-L}POI_{POST} 168, and corresponding measurement signals associated with measurement of additional structures by the high-throughput measurement system, MEAS-LS POST 161.

In these embodiments, machine learning module 162 generates estimated values of one or more parameters of interest, POI* 165, based on each set of measurement signals comprising ^{MEAS-L}S_{POST} 161 and each set of measurement signals comprising ^{MEAS-S}S_{POST} 175. Error evaluation module 163 receives the estimated values of the one or more parameters of interest, POI* 165, generated by machine learning module 162. In addition, error evaluation module 163 generates updated values of weighting parameters 164 of the machine learning model 162 undergoing training to minimize differences between the estimated values of the one or more parameters of interest, POI* 165, and the trusted values of the one or more parameters of interest associated with each set of measurement values, ^{EST-L}POI_{POST} 168 and each set of reference measurement value, ^{REF-S}POI_{POST} 152. In the next iteration of model training, new estimated values of the one or more parameters of interest, POI* 165, are generated by machine learning module 162 based on the values of the weighting parameters 164 generated in the previous iteration. The training process continues until the differences between the estimated values of the one or more parameters of interest, POI* 165, and the trusted values of the one or more parameters of interest associated with each set of measurement signals, ^{EST-L}POI_{POST} 168 and each set of reference measurement signals, ^{REF-S}POI_{POST} 152, are acceptably small. At this point, the trained post-process measurement model 169 is stored in a memory, e.g., memory 132.

In a further aspect, post-process measurement model training engine 160 includes a weighting module (not shown) that assigns a different weighting to actual, post-process reference measurement values, ^{REF-S}POI_{POST} 152, and corresponding measurement signals associated with measurement of the reference structures by a high-throughput measurement system, ^{MEAS-S}S_{POST} 175, than a weighting assigned to the augmented, post-process reference measurement values, ^{EST-L}POI_{POST} 168, and corresponding measurement signals associated with measurement of additional structures by the high-throughput measurement system, ^{MEAS-L}S_{POST} 161 for purposes of training. In some examples, the relative weighting depends on the goodness of fit, e.g., R² value, associated with the mapping model employed to model the relationship between pre-process measurement values and corresponding post-process measurement values as illustrated in FIG. 12. If the goodness of fit is relatively high, the weighting value associated with the augmented reference data set is assigned a value relatively close to the weighting value associated with the actual reference data set. If the goodness of fit is relatively low, the weighting value associated with the augmented reference data set is assigned a value significantly lower than the weighting value associated with the actual reference data set.

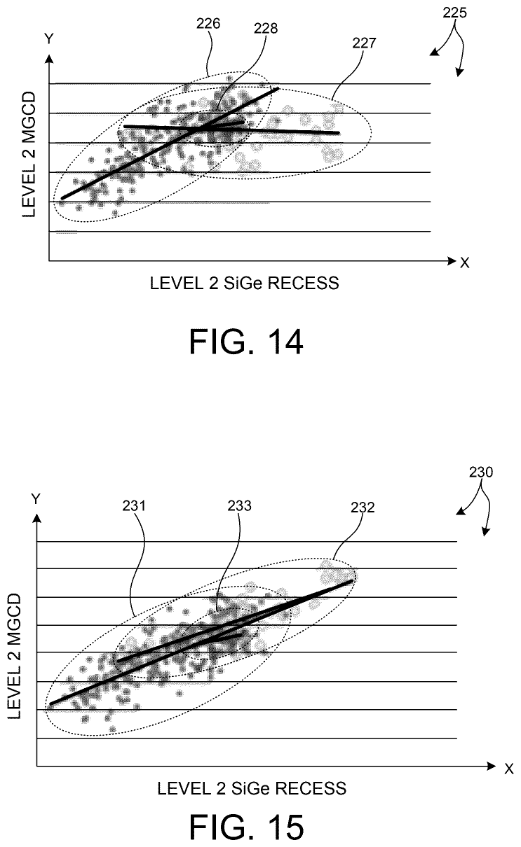

FIG. 14 is a plot 225 indicating an exemplary correlation between values of MGCD₂ estimated by a trained post-process measurement model as described herein and values of SiGe recess reliably measured in a pre-process state. The data points illustrated in FIG. 14 are associated with three different process recipes, e.g., different etch times, different etch recipes, etc. As depicted in FIG. 14, all of the data points associated with a first process recipe are captured by ellipse 226, all of the data points associated with a second process recipe are captured by ellipse 227, and all of the data points associated with a third process recipe are captured by ellipse 228. In the example depicted in FIG. 14, the post-process measurement model is trained based only on actual reference data. In this example, reference measurements were performed on 150 different instances of a nanosheet structure.

FIG. 15 is a plot 230 indicating an exemplary correlation between values of MGCD₂ estimated by a trained post-process measurement model as described herein and values of SiGe recess reliably measured in a pre-process state. The data points illustrated in FIG. 15 are associated with three different process recipes as described with reference to FIG. 14. As depicted in FIG. 15, all of the data points associated with a first process recipe are captured by ellipse 231, all of the data points associated with a second process recipe are captured by ellipse 232, and all of the data points associated with a third process recipe are captured by ellipse 233. In the example depicted in FIG. 15, the post-process measurement model is trained based on actual reference data and augmented reference data. In this example, actual reference measurements were performed on 150 different instances of a nanosheet structure, and augmented reference measurement data was generated for 2,000 additional instances of the nanosheet structure.

As depicted in FIGS. 14 and 15, the linearity of the correlations is much better across all three different process recipes. This indicates that the robustness of the trained post-process measurement model to process variation is much higher when augmented reference data is employed as described herein. In addition, the goodness of fit associated with each process recipe is improved when augmented reference data is employed. This indicates that the accuracy of the trained post-process measurement model is increased for all process recipes when augmented reference data is employed to train the post-process measurement model.

In another aspect, measurements of complex semiconductor structures are based on a combined measurement model including trained pre-process and post-process measurement models. Pre-process measurement data is employed directly as part of a combined ML based measurement and indirectly as part of the training data set for a combined ML based measurement model to take advantage of the correlation between structural characteristics of a measured sample before and after one or more intervening process steps.

In a further aspect, computing system 116 is configured to determine dimensions of a sample in a post-process state by providing measurement data at both a pre-process state and the post-process state as input to a combined ML based measurement model. The combined ML based measurement model is a machine learning based measurement model that determines dimensions of a sample based on measurement data provided as input to the model.

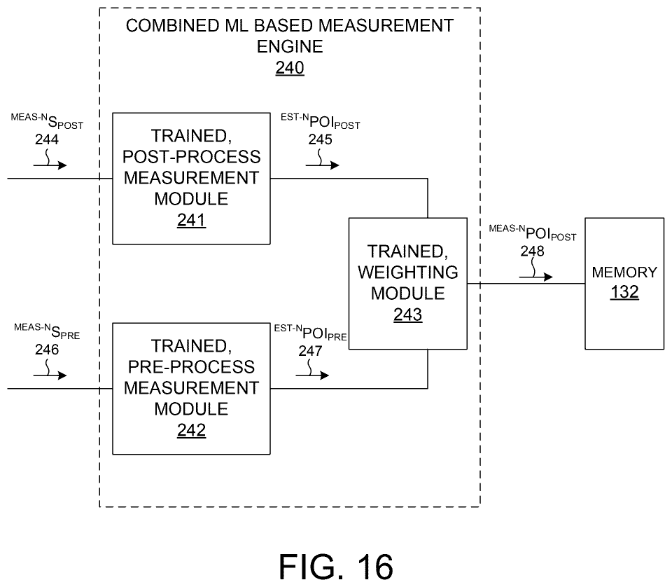

In the embodiment depicted in FIG. 16, computing system 116 is configured as a combined ML based measurement model engine 240 configured to implement model based measurement functionality as described herein. As depicted in FIG. 16, combined ML based measurement model engine 240 includes a trained, post-process measurement module 241 that generates estimated values of one or more parameters of interest, ^{EST-N}POI_{POST} 245, characterizing the shape of a structure under measurement in a post-process state, i.e., after a particular process step, based on raw measurement signals, ^{MEAS-N}S_{POST} 244, e.g., spectral measurement signals 111 depicted in FIG. 1. In addition, combined ML based measurement model engine 240 includes a trained, pre-process measurement module 242 that generates estimated values of one or more parameters of interest, ^{EST-N}POI_{PRE} 247, characterizing the shape of the structure under measurement in a pre-process state, i.e., before a particular process step, based on raw measurement signals, ^{MEAS-N}S_{PRE} 246, e.g., spectral measurement signals 111 depicted in FIG. 1. The estimated values of one or more parameters of interest, ^{EST-N}POI_{POST} 245, characterizing the shape of the structure under measurement in a post-process state and the estimated values of one or more parameters of interest, ^{EST-N}POI_{PRE} 247, characterizing the shape of the structure under measurement in a pre-process state are communicated to a trained weighting module 243. The trained weighting module 243 includes a trained weighting model that determines measured values of one or more parameters of interest characterizing the structure, ^{MEAS-N}POI_{POST} 248, based on ^{EST-N}POI_{PRE} 247 and ^{EST-N}POI_{POST} 245. The measured values, ^{MEAS-N}POI_{POST} 248, are stored in a memory, e.g., memory 132 depicted in FIG. 16.

In some embodiments, measurement system 100 is further configured to store a combined ML based measurement model engine 240 in a memory (e.g., carrier medium 118).

As illustrated by FIG. 16, measurements of a parameter of interest characterizing a structure in a post-process state require the collection of raw measurement data, e.g., spectral signals, at both a pre-process state and the post-process state. In addition, success requires process-based correlation between the pre-process state and post-process state. In some examples, the intervening process step is a SiGe recess etch step, an inner spacer deposition step, an inner spacer recess etch step, etc.

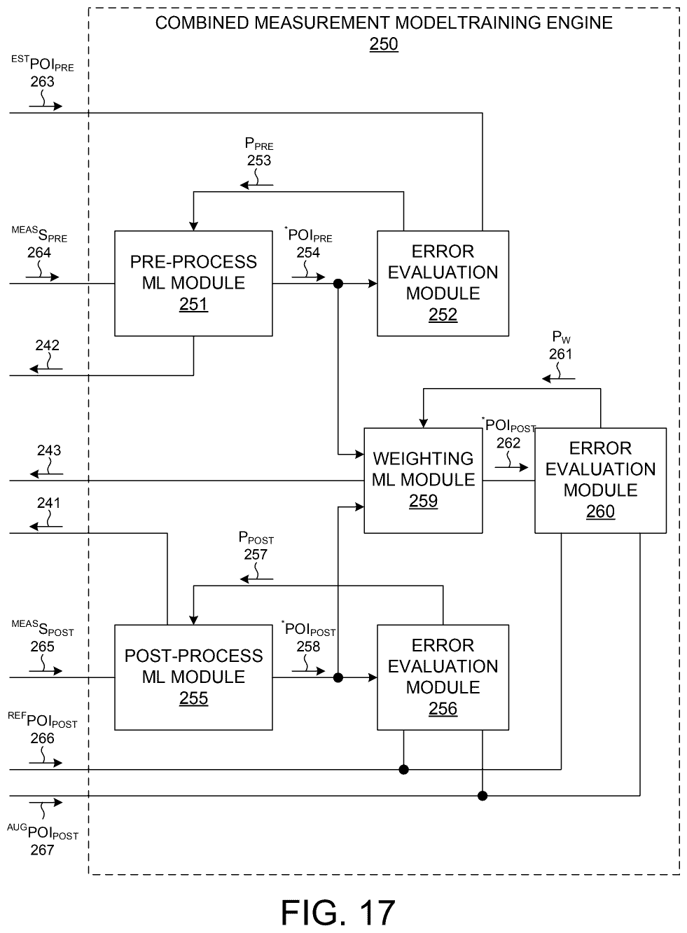

In a further aspect, computing system 116 is configured to train a combined ML based measurement model based at least in part on augmented reference data and raw measurement signals collected from a structure under measurement at both a pre-process state and a post-process state. The trained combined ML based measurement model includes a combination of two trained machine learning based measurement models and a trained machine learning based weighing model that determines dimensions of a sample based on measurement data collected at both a pre-process state and a post-process state. In the embodiment depicted in FIG. 17, computing system 116 is configured as a combined measurement model training engine.

FIG. 17 is a diagram illustrative of an exemplary combined measurement model training engine 250 implemented by computing system 116. As depicted in FIG. 17, combined measurement model training engine 250 includes pre-process ML module 251, error evaluation module 252, post-process ML module 255, error evaluation module 256, weighting ML module 259, and error evaluation module 260.

As depicted in FIG. 17, pre-process ML module 251 receives raw measurement signals, ^{MEAS}S_{PRE} 264, indicative of measurement signals, e.g., spectral signals, collected from measurements of many instances of a structure fabricated at many different wafer locations on many different wafers in a pre-process state. Similarly, post-process ML module 255 receives raw measurement signals, ^{MEAS}S_{POST} 265, indicative of measurement signals, e.g., spectral signals, collected from measurements of the same instances of the structure, but in a post-process state. ^{MEAS}S_{PRE} 264 and ^{MEAS}S_{POST} 265 are typically very large data sets collected using one or more instances of a high-throughput measurement system, e.g., a high-throughput optical critical dimension (OCD) measurement system such as the spectroscopic ellipsometry system depicted in FIG. 1, or different measurement systems. In general, however, any suitable high-throughput measurement system may be employed to collect measurement signals ^{MEAS}S_{PRE} 264 and ^{MEAS}S_{POST} 265. In some embodiments, the high-throughput measurement system employed to collect raw measurement signals ^{MEAS}S_{PRE} 264 is the same measurement system employed to collect raw measurement signals ^{MEAS}S_{POST} 265. In some embodiments, the high-throughput measurement system employed to collect raw measurement signals ^{MEAS}S_{PRE} 264 is a different instance of the same measurement system employed to collect raw measurement signals ^{MEAS}S_{POST} 265. In some embodiments, the high-throughput measurement system employed to collect raw measurement signals ^{MEAS}S_{PRE} 264 is different from the measurement system employed to collect raw measurement signals ^{MEAS}S_{POST} 265.

In addition, error evaluation module 252 receives estimated values of one or more parameters of interest, ^{EST}POI_{PRE} 263, characterizing the measured structure in the pre-process state at each of the different measurement locations and different wafers associated with measurement signals ^{MEAS}S_{PRE} 264. In some embodiments, a pre-process measurement model is employed to estimate the values of the one or more parameters of interest, ^{MEAS}S_{PRE} 264, based on the corresponding pre-process measurement signals, ^{MEAS}S_{PRE} 264, as described hereinbefore with reference to FIG. 3.

In addition, error evaluation module 256 receives actual reference measurement values or estimated values of one or more parameters of interest characterizing the measured structure in the post-process state at each of the different measurement locations and different wafers associated with measurement signals ^{MEAS}S_{POST} 265. Actual reference measurement values, ^{REF}POI_{POST} 266, in the post-process state are collected at a small subset of the different measurement locations and different wafers. In addition, augmented reference measurement values, ^{AUG}POI_{POST} 267, in the post-process state are generated at the remaining measurement locations and different wafers.

The actual reference measurements are performed by a reference measurement system, e.g., TEM, SEM, AFM, etc. as described with reference to FIGS. 3 and 4. Similarly, the augmented reference measurements are generated based on a trained mapping model as described with reference to FIGS. 3 and 4. As described with reference to FIGS. 3 and 4, a trained mapping model is a trained mathematical function, e.g., trained linear function, trained non-linear function, etc., that maps each estimated value of each parameter of interest at each different measurement location and different wafer in the pre-process state to corresponding estimated values of each parameter of interest at each different measurement location and different wafer in the post-process state. The trained mapping model is trained as described with respect to FIG. 4, based on actual reference measurement values, ^{REF}POI_{POST} 266, in the post-process state and corresponding measured values of one or more parameters of interest characterizing the measured structure in a pre-process state.

In some examples, the augmented reference measurements are generated in two steps. First, a pre-process measurement model is employed to estimate values of one or more parameters of interest in a pre-process state based on corresponding pre-process measurement signals. The estimated values are generated for measurement instances where actual reference measurement data is not available. Second, a trained mapping model is employed to estimate the values of the augmented reference measurements, ^{AUG}POI_{POST} 267, in the post-process state based on the estimated values of one or more parameters of interest in the pre-process state for the measurement instances where actual reference measurement data is not available. In some other examples, the values of one or more parameters of interest in a pre-process state are available. In these examples, a trained mapping model is employed to directly estimate the values of the augmented reference measurements, ^{AUG}POI_{POST} 267, in the post-process state based on the estimated values of one or more parameters of interest in the pre-process state for the measurement instances where actual reference measurement data is not available.

As depicted in FIG. 17, the training of a combined ML based measurement model involves the training of three different machine learning based models simultaneously, a trained, post-process measurement model 241 comprising trained, post-process measurement module 241 depicted in FIG. 3, a trained, pre-process measurement model 242 comprising trained, post-process measurement module 242 depicted in FIG. 3, and a trained weighting model 243 comprising trained weighting module 243 depicted in FIG. 3.

As depicted in FIG. 17, pre-process ML module 251 generates estimated values of one or more parameters of interest, *POI_{PRE} 254, in a pre-process state based on each set of measurement signals comprising ^{MEAS}S_{PRE} 264. Error evaluation module 252 receives *POI_{PRE} 254 and generates updated values of weighting parameters, P_{PRE} 253, of the pre-process ML model 251 undergoing training to minimize differences between the estimated values of the one or more parameters of interest, *POI_{PRE} 254, and the trusted values of the one or more parameters of interest, ^{EST}POI_{PRE} 263, associated with each set of measurements. In the next iteration of model training, new estimated values of the one or more parameters of interest, *POI_{PRE} 254, are generated by pre-process ML model 251 based on the values of the weighting parameters, P_{PRE} 253, generated in the previous iteration. The training process continues until the differences between the estimated values of the one or more parameters of interest, *POI_{PRE} 254, and the trusted values of the one or more parameters of interest associated with each set of measurement signals, ^{EST}POI_{PRE} 263, are acceptably small. At this point, the trained pre-process measurement model 242 is stored in a memory, e.g., memory 132.

Similarly, post-process ML module 255 generates estimated values of one or more parameters of interest, *POI_{POST} 258, in a post-process state based on each set of measurement signals comprising ^{MEAS}S_{POST} 265. Error evaluation module 256 receives *POI_{POST} 258 and generates updated values of weighting parameters, P_{POST} 257, of the post-process ML model 255 undergoing training to minimize differences between the estimated values of the one or more parameters of interest, *POI_{POST} 258, and the reference measurement values of the one or more parameters of interest, ^{REF}POI_{POST} 266, associated with the small subset of measurements, and the augmented reference values of the one or more parameters of interest, ^{AUG}POI_{POST} 267, associated with the remaining measurements. In the next iteration of model training, new estimated values of the one or more parameters of interest, *POI_{POST} 258, are generated by post-process ML model 255 based on the values of the weighting parameters, P_{POST} 257, generated in the previous iteration. The training process continues until the differences between the estimated values of the one or more parameters of interest, *POI_{POST} 258, and the actual reference values, ^{REF}POI_{POST} 266, and the augmented reference values, ^{AUG}POI_{POST} 267, are acceptably small. At this point, the trained post-process measurement model 241 is stored in a memory, e.g., memory 132.

Similarly, weighting ML module 259 generates estimated values of one or more parameters of interest, *POI_{POST} 262, in a post-process state based on the estimated values *POI_{PRE} 254 and *POI_{POST} 258. Error evaluation module 260 receives *POI_{POST} 262 and generates updated values of weighting parameters, Pw 261, of the weighting ML model 259 undergoing training to minimize differences between the estimated values of the one or more parameters of interest, *POI_{POST} 262, and the reference measurement values of the one or more parameters of interest, ^{REF}POI_{POST} 266, associated with the small subset of measurements, and the augmented reference values of the one or more parameters of interest, ^{AUG}POI_{POST} 267, associated with the remaining measurements. In the next iteration of model training, new estimated values of the one or more parameters of interest, *POI_{POST} 262, are generated by weighting ML model 259 based on the values of the weighting parameters, Pw 261, generated in the previous iteration. The training process continues until the differences between the estimated values of the one or more parameters of interest, *POI_{POST} 262, and the actual reference values, ^{REF}POI_{POST} 266, and the augmented reference values, ^{AUG}POI_{POST} 267, are acceptably small. At this point, the trained weighting model 243 is stored in a memory, e.g., memory 132.

In general, augmented reference measurement data may be generated from measurements at more than one pre-process state and a post-process state in a manner analogous to that described herein with reference to FIGS. 3, 4, 16, and 17.

In general, augmented reference measurement data is employed to generate measurement models of complex memory structures, e.g., 3D flash memory, DRAM cells, multi-deck VNAND structures, etc., and complex logic structures cells, e.g., Gate-All-Around structures, forksheet structures, complementary field effect transistor (CFET) structures, high power devices structures, III-V based structures etc.

The flexibility of building measurement models using augmented reference measurement data enables rapid measurement recipe generation based on relatively large data sets, including data sets acquired during production. This allows fabrication facilities to quickly refine process conditions to improve yield of FinFET structures, Gate-All-Around structures, DRAM and VNAND memory structures, etc. In many cases, the only other available alternatives to measurement of these high aspect ratio structures are destructive techniques, such as Focused Ion Beam microscopy, and extremely low throughtput techniques, such as Transmission Electron Microscopy (TEM).

It should be recognized that the various steps described throughout the present disclosure may be carried out by single computer systems 116, or, alternatively, multiple computer systems 116. Moreover, different subsystems of system 100, such as the spectroscopic ellipsometer 101, may include a computer system suitable for carrying out at least a portion of the steps described herein. Therefore, the aforementioned description should not be interpreted as a limitation on the present invention but merely an illustration. Further, the one or more computing systems 116 may be configured to perform any other step(s) of any of the method embodiments described herein.

The computing system 116 may include, but is not limited to, a personal computer system, mainframe computer system, cloud-based computing system, workstation, image computer, parallel processor, or any other device known in the art. In general, the term “computing system” may be broadly defined to encompass any device having one or more processors, which execute instructions from a memory medium. In general, computing system 116 may be integrated with a measurement system such as measurement system 100, or alternatively, may be separate from any measurement system. In this sense, computing system 116 may be remotely located and receive measurement data from any measurement source.

Program instructions 120 implementing methods such as those described herein may be transmitted over or stored on carrier medium 118. The carrier medium may be a transmission medium such as a wire, cable, or wireless transmission link. The carrier medium may also include a computer-readable medium such as a read-only memory, a random access memory, a magnetic or optical disk, or a magnetic tape.

Although the methods discussed herein are explained with reference to system 100, any optical or x-ray based metrology system configured to illuminate and detect light reflected, transmitted, or diffracted from a specimen may be employed to implement the exemplary methods described herein. Exemplary systems include an angle-resolved reflectometer, a scatterometer, a reflectometer, an ellipsometer, a spectroscopic reflectometer or ellipsometer, a beam profile reflectometer, a multi-wavelength, two-dimensional beam profile reflectometer, a multi-wavelength, two-dimensional beam profile ellipsometer, a rotating compensator spectroscopic ellipsometer, an optically modulated reflectometer, an optically modulated ellipsometer, a transmissive x-ray scatterometer, a reflective x-ray scatterometer, etc. By way of non-limiting example, an ellipsometer may include a single rotating compensator, multiple rotating compensators, a rotating polarizer, a rotating analyzer, a modulating element, multiple modulating elements, or no modulating element.

It is noted that the output from a measurement system may be configured in such a way that the measurement system uses more than one technology. In fact, an application may be configured to employ any combination of available metrology sub-systems within a single tool, or across a number of different tools.

A system implementing the methods described herein may also be configured in a number of different ways. For example, a wide range of wavelengths (including visible, ultraviolet, infrared, and X-ray), angles of incidence, states of polarization, and states of coherence may be contemplated. In another example, the system may include any of a number of different light sources (e.g., a directly coupled light source, a laser-sustained plasma light source, etc.). In another example, the system may include elements to condition light directed to or collected from the specimen (e.g., apodizers, filters, etc.).

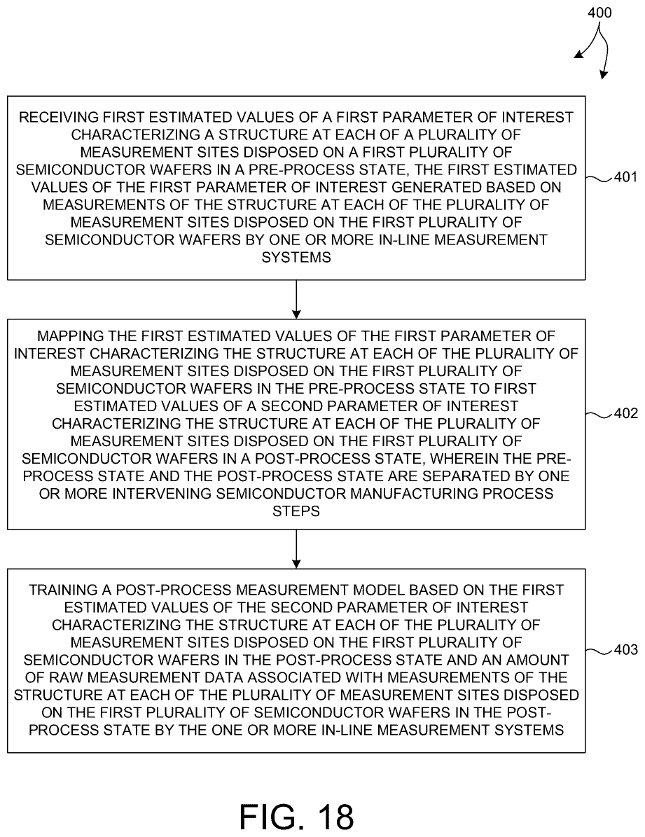

FIG. 18 illustrates a method 400 suitable for implementation by metrology system 100 of the present invention. In one aspect, it is recognized that data processing blocks of method 400 may be carried out via a pre-programmed algorithm executed by one or more processors of computing system 116. While the following description is presented in the context of metrology system 100, it is recognized herein that the particular structural aspects of metrology system 100 do not represent limitations and should be interpreted as illustrative only.

In block 401, first estimated values of a first parameter of interest characterizing a structure at each of a plurality of measurement sites disposed on a first plurality of semiconductor wafers in a pre-process state are received, e.g., by computing system 116. The first estimated values of the first parameter of interest are generated based on measurements of the structure at each of the plurality of measurement sites disposed on the first plurality of semiconductor wafers by one or more in-line measurement systems.

In block 402, the first estimated values of the first parameter of interest characterizing the structure at each of the plurality of measurement sites disposed on the first plurality of semiconductor wafers in the pre-process state are mapped to first estimated values of a second parameter of interest characterizing the structure at each of the plurality of measurement sites disposed on the first plurality of semiconductor wafers in a post-process state. The pre-process state and the post-process state are separated by one or more intervening semiconductor manufacturing process steps.

In block 403, a post-process measurement model is trained based on the first estimated values of the second parameter of interest characterizing the structure at each of the plurality of f measurement sites disposed on the first plurality of semiconductor wafers in the post-process state and an amount of raw measurement data associated with measurements of the structure at each of the plurality of measurement sites disposed on the first plurality of semiconductor wafers in the post-process state by the one or more in-line measurement systems.

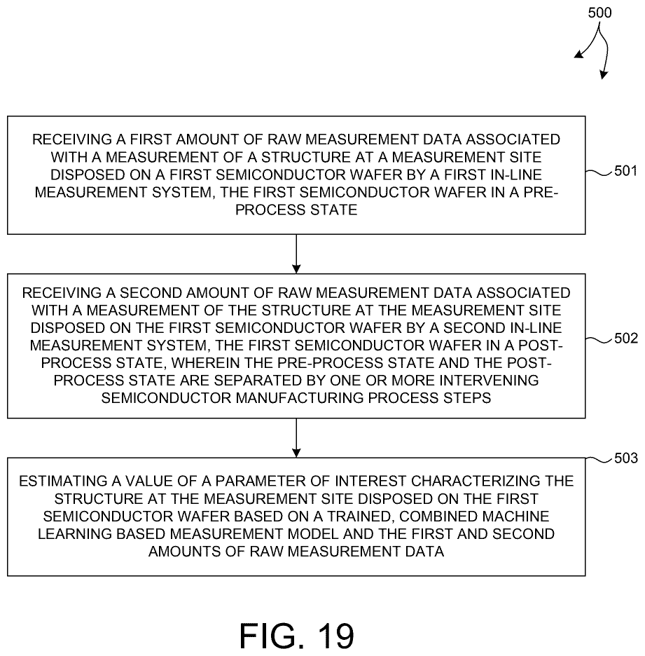

FIG. 19 illustrates a method 500 suitable for implementation by metrology system 100 of the present invention. In one aspect, it is recognized that data processing blocks of method 500 may be carried out via a pre-programmed algorithm executed by one or more processors of computing system 116. While the following description is presented in the context of metrology system 100, it is recognized herein that the particular structural aspects of metrology system 100 do not represent limitations and should be interpreted as illustrative only.

In block 501, a first amount of raw measurement data associated with a measurement of a structure at a measurement site disposed on a first semiconductor wafer by a first in-line measurement system is received, e.g., by computing system 116. The first semiconductor wafer is in a pre-process state.

In block 502, a second amount of raw measurement data associated with a measurement of the structure at the measurement site disposed on the first semiconductor wafer by a second in-line measurement system is received, e.g., by computing system 116. The first semiconductor wafer is in a post-process state. Moreover, the pre-process state and the post-process state are separated by one or more intervening semiconductor manufacturing process steps.

In block 503, a value of a parameter of interest characterizing the structure at the measurement site disposed on the first semiconductor wafer is estimated based on a trained, combined machine learning based measurement model and the first and second amounts of raw measurement data.

As described herein, the term “critical dimension” includes any critical dimension of a structure (e.g., bottom critical dimension, middle critical dimension, top critical dimension, sidewall angle, grating height, etc.), a critical dimension between any two or more structures (e.g., distance between two structures), a displacement between two or more structures (e.g., overlay displacement between overlaying grating structures, etc.), and a dispersion property value of a material used in the structure or part of the structure. Structures may include three dimensional structures, patterned structures, overlay structures, etc.

As described herein, the term “critical dimension application” or “critical dimension measurement application” includes any critical dimension measurement.

As described herein, the term “metrology system” includes any system employed at least in part to characterize a specimen in any aspect. However, such terms of art do not limit the scope of the term “metrology system” as described herein. In addition, the metrology system 100 may be configured for measurement of patterned wafers and/or unpatterned wafers. The metrology system may be configured as a LED inspection tool, edge inspection tool, backside inspection tool, macro-inspection tool, or multi-mode inspection tool (involving data from one or more platforms simultaneously), and any other metrology or inspection tool that benefits from the calibration of system parameters based on critical dimension data.

Various embodiments are described herein for a semiconductor processing system (e.g., an inspection system or a lithography system) that may be used for processing a specimen. The term “specimen” is used herein to refer to a site, or sites, on a wafer, a reticle, or any other sample that may be processed (e.g., printed or inspected for defects) by means known in the art. In some examples, the specimen includes a single site having one or more measurement targets whose simultaneous, combined measurement is treated as a single specimen measurement or reference measurement. In some other examples, the specimen is an aggregation of sites where the measurement data associated with the aggregated measurement site is a statistical aggregation of data associated with each of the multiple sites. Moreover, each of these multiple sites may include one or more measurement targets associated with a specimen or reference measurement.

As used herein, the term “wafer” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a wafer may include only the substrate (i.e., bare wafer). Alternatively, a wafer may include one or more layers of different materials formed upon a substrate. One or more layers formed on a wafer may be “patterned” or “unpatterned.” For example, a wafer may include a plurality of dies having repeatable pattern features.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as amorphous SiO₂. A reticle may be disposed above a resist-covered wafer during an exposure step of a lithography process such that the pattern on the reticle may be transferred to the resist.

One or more layers formed on a wafer may be patterned or unpatterned. For example, a wafer may include a plurality of dies, each having repeatable pattern features. Formation and processing of such layers of material may ultimately result in completed devices. Many different types of devices may be formed on a wafer, and the term wafer as used herein is intended to encompass a wafer on which any type of device known in the art is being fabricated.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A measurement system comprising:
an illumination subsystem configured to illuminate a structure with an amount of radiation at each of a plurality of measurement sites disposed on a first plurality of semiconductor wafers in a pre-process state;
a detector configured to detect an amount of raw measurement data associated with the measurements of the structure at each of the plurality of measurement sites disposed on the first plurality of semiconductor wafers in response to the amount of radiation; and
a computing system configured to:
receive first estimated values of a first parameter of interest characterizing the structure at each of the plurality of measurement sites disposed on the first plurality of semiconductor wafers in the pre-process state, the first estimated values of the first parameter of interest generated based on the measurements of the structure at each of the plurality of measurement sites disposed on the first plurality of semiconductor wafers;
map the first estimated values of the first parameter of interest characterizing the structure at each of the plurality of measurement sites disposed on the first plurality of semiconductor wafers in the pre-process state to first estimated values of a second parameter of interest characterizing the structure at each of the plurality of measurement sites disposed on the first plurality of semiconductor wafers in a post-process state, wherein the pre-process state and the post-process state are separated by one or more intervening semiconductor manufacturing process steps; and
train a post-process measurement model based on the first estimated values of the second parameter of interest characterizing the structure at each of the plurality of measurement sites disposed on the first plurality of semiconductor wafers in the post-process state and an amount of raw measurement data associated with measurements of the structure at each of the plurality of measurement sites disposed on the first plurality of semiconductor wafers in the post-process state.

2. The measurement system of claim 1,
wherein the illumination subsystem is further configured to illuminate the structure with a second amount of radiation at each of one or more reference measurement sites disposed on a second plurality of semiconductor wafers in the pre-process state;
wherein the detector is further configured to detect an amount of raw measurement data associated with the measurements of the structure at each of the one or more reference measurement sites disposed on the second plurality of semiconductor wafers in response to the second amount of radiation; and
wherein the computing system is further configured to:
receive second estimated values of a first parameter of interest characterizing the structure at each of the one or more reference measurement sites disposed on the second plurality of semiconductor wafers in the pre-process state, the second estimated values of the first parameter of interest generated based on the measurements of the structure at each of the one or more reference measurement sites disposed on the second plurality of semiconductor wafers;
receive second estimated values of the second parameter of interest characterizing the structure at each of the one or more reference measurement sites disposed on the second plurality of semiconductor wafers in the post-process state, the second estimated values of the second parameter of interest generated based on measurements of the structure at each of the one or more reference measurement sites disposed on the second plurality of semiconductor wafers by one or more reference measurement systems; and
generate a mapping model that maps the second estimated values of the first parameter of interest to the second estimated values of the second parameter of interest.

3. The measurement system of claim 1, wherein the first parameter of interest and the second parameter of interest are the same parameter.

4. The measurement system of claim 2, further comprising:
training the post-process measurement model based on the second estimated values of the second parameter of interest characterizing the structure at each of the one or more reference measurement sites disposed on the second plurality of semiconductor wafers in the post-process state and an amount of raw measurement data associated with measurements of the structure at each of the one or more reference measurement sites disposed on the second plurality of semiconductor wafers in the post-process state.

5. The measurement system of claim 4, the computing system further configured to:
weigh the second estimated values of the second parameter of interest characterizing the structure at each of the one or more reference measurement sites disposed on the second plurality of semiconductor wafers in the post-process state differently than the first estimated values of the second parameter of interest characterizing the structure at each of the plurality of measurement sites disposed on the first plurality of semiconductor wafers in the post-process state during the training.

6. A method comprising
receiving first estimated values of a first parameter of interest characterizing a structure at each of a plurality of measurement sites disposed on a first plurality of semiconductor wafers in a pre-process state, the first estimated values of the first parameter of interest generated based on measurements of the structure at each of the plurality of measurement sites disposed on the first plurality of semiconductor wafers by one or more in-line measurement systems;
mapping the first estimated values of the first parameter of interest characterizing the structure at each of the plurality of measurement sites disposed on the first plurality of semiconductor wafers in the pre-process state to first estimated values of a second parameter of interest characterizing the structure at each of the plurality of measurement sites disposed on the first plurality of semiconductor wafers in a post-process state, wherein the pre-process state and the post-process state are separated by one or more intervening semiconductor manufacturing process steps; and
training a post-process measurement model based on the first estimated values of the second parameter of interest characterizing the structure at each of the plurality of measurement sites disposed on the first plurality of semiconductor wafers in the post-process state and an amount of raw measurement data associated with measurements of the structure at each of the plurality of measurement sites disposed on the first plurality of semiconductor wafers in the post-process state by the one or more in-line measurement systems.

7. The method of claim 1, further comprising:
receiving second estimated values of a first parameter of interest characterizing the structure at each of one or more reference measurement sites disposed on a second plurality of semiconductor wafers in the pre-process state, the second estimated values of the first parameter of interest generated based on measurements of the structure at each of the one or more reference measurement sites disposed on the second plurality of semiconductor wafers by the one or more in-line measurement systems;
receiving second estimated values of the second parameter of interest characterizing the structure at each of the one or more reference measurement sites disposed on the second plurality of semiconductor wafers in the post-process state, the second estimated values of the second parameter of interest generated based on measurements of the structure at each of the one or more reference measurement sites disposed on the second plurality of semiconductor wafers by one or more reference measurement systems; and
generating a mapping model that maps the second estimated values of the first parameter of interest to the second estimated values of the second parameter of interest.

8. The method of claim 1, wherein the first parameter of interest and the second parameter of interest are the same parameter.

9. The method of claim 1, wherein the one or more reference measurement systems employ a different metrology technique than the one or more in-line measurement systems.

10. The method of claim 1, wherein the post-process measurement model is a machine learning based measurement model.

11. The method of claim 1, further comprising:
illuminating the structure at each of the plurality of measurement sites disposed on the first plurality of semiconductor wafers in the pre-process state;
detecting the amount of raw measurement data associated with the measurements of the structure at each of the plurality of measurement sites disposed on the first plurality of semiconductor wafers in response to the illumination; and
estimating the first estimated values of the first parameter of interest based on the amount of raw measurement data.

12. The method of claim 7, further comprising:
illuminating the structure at each of the one or more reference measurement sites disposed on the second plurality of semiconductor wafers in the pre-process state;
detecting an amount of raw measurement data in response to the illumination; and
estimating the second estimated values of the first parameter of interest based on the amount of raw measurement data.

13. The method of claim 7, further comprising:
training the post-process measurement model based on the second estimated values of the second parameter of interest characterizing the structure at each of the one or more reference measurement sites disposed on the second plurality of semiconductor wafers in the post-process state and an amount of raw measurement data associated with measurements of the structure at each of the one or more reference measurement sites disposed on the second plurality of semiconductor wafers in the post-process state by the one or more in-line measurement systems.

14. The method of claim 13, further comprising:
weighing the second estimated values of the second parameter of interest characterizing the structure at each of the one or more reference measurement sites disposed on the second plurality of semiconductor wafers in the post-process state differently than the first estimated values of the second parameter of interest characterizing the structure at each of the plurality of measurement sites disposed on the first plurality of semiconductor wafers in the post-process state during the training.

15. The method of claim 6, further comprising:
receiving an amount of raw measurement data associated with a measurement of the structure at a measurement site disposed on a third semiconductor wafer in the post-process state by one of the one or more in-line measurement systems; and
estimating a value of the second parameter of interest characterizing the structure at the measurement site disposed on the third semiconductor wafer in the post-process state based on the received amount of raw measurement data and the trained post-process measurement model.

16. A measurement system comprising:
an illumination subsystem configured to illuminate a structure with a first amount of radiation at a first measurement site disposed on a first semiconductor wafer in a pre-process state and illuminate the structure with a second amount of radiation at the first measurement site disposed on the first semiconductor wafer in a post-process state, wherein the pre-process state and the post-process state are separated by one or more intervening semiconductor manufacturing process steps;
a detector configured to detect a first amount of raw measurement data associated with a measurement of the structure at the first measurement site disposed on the first semiconductor wafer in response to the first amount of radiation and detect a second amount of raw measurement data associated with a measurement of the structure at the first measurement site disposed on the first semiconductor wafer in response to the second amount of radiation; and
a computing system configured to:
receive the first and second amounts of raw measurement data; and
estimate a value of a parameter of interest characterizing the structure at the first measurement site disposed on the first semiconductor wafer based on a trained, combined machine learning based measurement model and the first and second amounts of raw measurement data.

17. The measurement system of claim 16, wherein the trained, combined machine learning based measurement model includes a trained, pre-process measurement model, a trained, post-process measurement model, and a trained weighting model.

18. The measurement system of claim 17, wherein the first amount of raw measurement data is provided as input to the trained, pre-process measurement model, wherein the second amount of raw measurement data is provided as input to the trained, post-process measurement model, and wherein an output of the trained, pre-process measurement model and an output of the trained, post-process measurement model is provided as input to the trained weighting model, and wherein the output of the trained weighting model is the estimated value of the parameter of interest.

19. A method comprising:
receiving a first amount of raw measurement data associated with a measurement of a structure at a measurement site disposed on a first semiconductor wafer by a first in-line measurement system, the first semiconductor wafer in a pre-process state;
receiving a second amount of raw measurement data associated with a measurement of the structure at the measurement site disposed on the first semiconductor wafer by a second in-line measurement system, the first semiconductor wafer in a post-process state, wherein the pre-process state and the post-process state are separated by one or more intervening semiconductor manufacturing process steps; and
estimating a value of a parameter of interest characterizing the structure at the measurement site disposed on the first semiconductor wafer based on a trained, combined machine learning based measurement model and the first and second amounts of raw measurement data.

20. The method of claim 19, wherein the trained, combined machine learning based measurement model includes a trained, pre-process measurement model, a trained, post-process measurement model, and a trained weighting model.

21. The method of claim 20, wherein the first amount of raw measurement data is provided as input to the trained, pre-process measurement model, wherein the second amount of raw measurement data is provided as input to the trained, post-process measurement model, and wherein an output of the trained, pre-process measurement model and an output of the trained, post-process measurement model is provided as input to the trained weighting model, and wherein the output of the trained weighting model is the estimated value of the parameter of interest.

22. The method of claim 20, wherein the trained, pre-process measurement model, the trained, post-process measurement model, and the trained weighting model are trained simultaneously.

23. The method of claim 19, wherein the first in-line measurement system and the second in-line measurement system are the same measurement system.
